(19) United States
(12) Patent Application Publication
(10) Pub. No.: US 2009/0060552 A1
(43) Pub. Date: Mar. 5, 2009

(54) IMAGE FORMING APPARATUS

(75) Inventor: Eiji OKABAYASHI, Toyokawa-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/198,638

(22) Filed: Aug. 26, 2008

(30) Foreign Application Priority Data
Aug. 31, 2007 (JP) 2007-226181

(51) Int. Cl. G03G 15/20

(52) U.S. Cl. 399/70

(57) ABSTRACT

A warm-up operation control section performs warm-up operation of a fixing-side rotation unit and a pressure-side rotation unit from start-up until the temperature of the fixing-side rotation unit exceeds a first specified value based on an output of a heating-side thermistor in forming a monochrome image. In forming a color image, the warm-up operation control section performs warm-up operation of the fixing-side rotation unit and the pressure-side rotation unit from start-up until the temperature of the pressure-side rotation unit exceeds a second specified value based on an output of a pressure-side thermistor. Time required for the temperature of the fixing-side rotation unit to exceed the first specified value is set shorter than time required for temperature of the pressure-side rotation unit to exceed the second specified value.

### CROSS-REFERENCE TO RELATED APPLICATION

This application is based on application No. 2007-226181 filed in Japan, the entire content of which is hereby incorporated by reference.

### BACKGROUND OF THE INVENTION

The present invention relates to an image forming apparatus such as an electrophotographic copying machine or printer.

Conventionally, there has been an image forming apparatus wherein it is not until temperatures of both a heating roller and a pressure roller reach predetermined ones that monochrome or color printing is permitted, at the time of the warm-up operation after turn-on of power supply (see JP 2005-189773A).

The conventional image forming apparatus has both a monochrome mode and a color mode, in general. However, in most cases, the monochrome mode is used by users.

Conventionally, completion of the warm-up operation is determined on the basis of the color-mode which requires more severe conditions in fixability than monochrome-mode. This forces the users using the apparatus in monochrome mode to wait for a longer time than necessary.

### BRIEF SUMMARY OF THE INVENTION

An object of the present invention is to provide an image forming apparatus which can reduce the warm-up time and can thereby reduce waiting time of users using in the monochrome mode.

In order to achieve the above-mentioned object, a one aspect of the present invention provides an image forming apparatus having a fixing-side rotation unit, a fixing-side heating section which heats the fixing-side rotation unit, a pressure-side rotation unit which contacts the fixing-side rotation unit to form a nip section, a first temperature sensor which detects temperature of the fixing-side rotation unit, a second temperature sensor which detects temperature of the pressure-side rotation unit, and a warm-up operation control section which performs warm-up operation of the fixing-side rotation unit and the pressure-side rotation unit from start-up until temperature of the fixing-side rotation unit exceeds a first specified value based on an output of the first temperature sensor in a case of forming a monochrome image, and which performs warm-up operation of the fixing-side rotation unit and the pressure-side rotation unit from start-up until temperature of the pressure-side rotation unit exceeds a second specified value based on an output of the second temperature sensor in a case of forming a color image, wherein time required for the temperature of the fixing-side rotation unit to exceed the first specified value is set shorter than time required for temperature of the pressure-side rotation unit to exceed the second specified value.

Herein, the monochrome image refers to an image in which one layer of toner is formed on a recording material. The color image refers to an image in which a plurality of layers (e.g., 2 to 3 layers) of toner is formed on a recording material.

According to the one aspect of the present invention, the image forming apparatus has the warm-up operation control section wherein time required for the temperature of the fixing-side rotation unit to exceed the first specified value is set shorter than time required for temperature of the pressure-side rotation unit to exceed the second specified value. Thus, in the case of forming a monochrome image, it is not necessary to put the image forming apparatus in a standby state until the temperature of the pressure-side rotation unit exceeds the second specified value.

Therefore, the warm-up time in the monochrome mode can be reduced, and thereby the waiting time of the users using the monochrome mode can be reduced.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a schematic view of an image forming apparatus in one embodiment of the present invention;

FIG. 2A shows a schematic view of a fixing device in a state of pressure contact;

FIG. 2B shows a schematic view of the fixing device in a state of light pressure contact;

FIG. 3 shows a block diagram of a control device;

FIG. 4 shows a graph indicating warm-up completion conditions for fixing operation in monochrome mode and color mode in the image forming apparatus of the present invention; and

FIG. 5 is a control flow chart of the present invention.

### DETAILED DESCRIPTION OF THE INVENTION

Hereinbelow, the present invention will be described in details in conjunction with the embodiments with reference to the drawings.

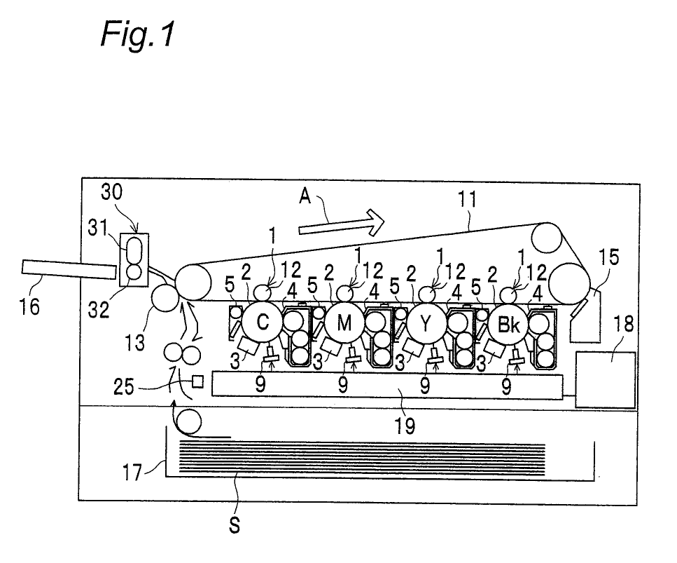

An image forming apparatus in one embodiment of the present invention is a color printer having image forming units 1, as shown in FIG. 1. The image forming units 1 respectively form color toner images of black (BK), yellow (Y), magenta (M) and cyan (C). The image forming units 1 for BK, Y, M, and C are respectively placed in this order from an upper stream side of an intermediate transfer belt 11 along this belt 11 which rotates in the direction of an arrow “A”.

The image forming unit 1 has a photoconductor drum 2, a charging section 3 for uniformly charging the photoconductor drum 2, an exposure section 9 for performing image exposure of the charged photoconductor drum 2, and a developing section 4 for developing an electrostatic latent image formed by the exposure with use of the toner of each color. The developed toner image is primarily transferred to the intermediate transfer belt 11 by a primary transfer section 12. After the primary transfer, the toner remaining on the photoconductor drum 2 is removed by a cleaning section 5 placed downstream. Then, the toner is withdrawn from the lower side of the cleaning section 5.

More specifically, in the image forming unit 1, the toner image developed on the photoconductor drum 2 is transferred onto the intermediate transfer belt 11 by the primary transfer section 12 at a contact position with the intermediate transfer belt 11. Every time the intermediate transfer belt 11 passes each of the image forming units 1, a toner image is surprinted on the intermediate transfer belt 11, resulting in that a full color toner images are formed on the intermediate transfer belt 11.

Thereafter, the full color toner images transferred onto the intermediate transfer belt 11 are collectively transferred onto a recording material S, such as paper sheets, on the downstream side by a secondary transfer section 13. Then, the recording material S passes through a fixing device 30 so as to fix the toner images on the recording material S. Finally, the recording material S is delivered onto a paper output tray 16. The fixing device 30 has a fixing-side rotation unit 31 and a pressure-side rotation unit 32.

The recording material S is stored in a record sheet cassette 17 which is located at the lowermost position. The recording material S is transported to the transfer section 13 sheet by sheet. The residual toner on the intermediate transfer belt 11 after the secondary transfer is removed from the surface of the intermediate transfer belt 11 by a cleaning blade 15. Then, the residual toner is transported by an unshown conveyance screw and collected in an unshown waste toner bottle.

A control device 18 entirely controls the image forming apparatus (the color printer in this embodiment) The control device 18 sends signals corresponding to images to an exposure controller 19. The exposure controller 19 drives each of the exposure sections 9 according to respective colors.

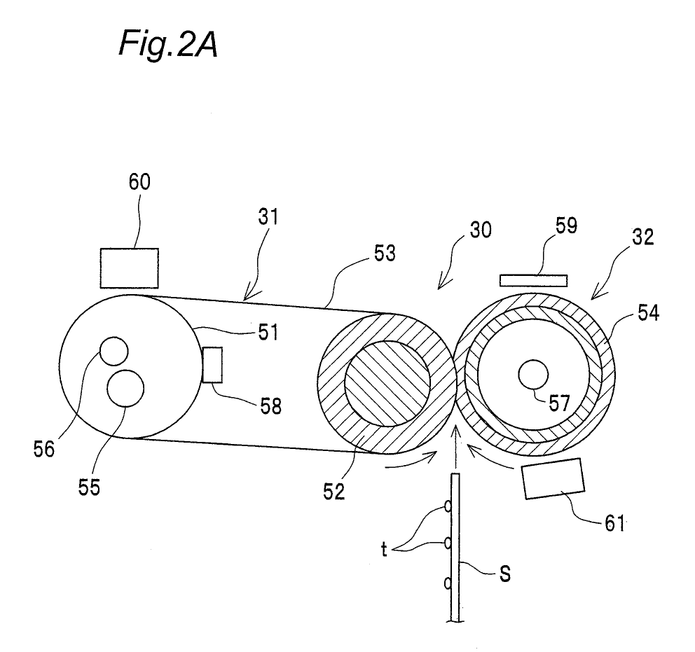

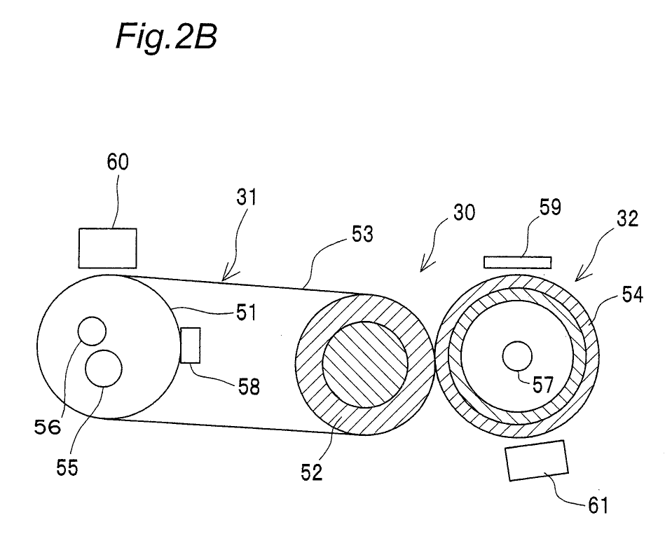

As shown in FIG. 2A and FIG. 2B, the fixing device 30 has a fixing-side rotation unit 31 and a pressure-side rotation unit 32. The pressure-side rotation unit 32 contacts the fixing-side rotation unit 31, and thereby a nip section is formed. Toner t is fixed onto the recording material S in the nip section. The fixing-side rotation unit 31 is placed on the side of the toner t which is to be fixed onto the recording material S. The pressure-side rotation unit 32 is placed on the opposite side to the toner t.

FIG. 2A shows a pressure contact state at the time of rotation, while FIG. 2B shows a light pressure contact state at the time of stop. The light pressure contact state at the time of stop aims at preventing creep deformation of a fixing roller 52 which has a sponge layer. The light pressure contact state is also used as an envelope paper feed mode for a thick sheet of paper. The thick sheet of paper suffers paper-wrinkling if it is fed in the pressure contact state.

The fixing-side rotation unit 31 has a heating roller 51, a fixing roller 52 and a fixing belt 53. The heating roller 51 is 30 mm in outer diameter and 330 mm in axial length, for example. The heating roller 51 has an aluminum hollow cored bar (0.6 mm in thickness) and a PTFE (Polytetrafluoroethylene) coating (15 micrometers in thickness), for example. The fixing roller 52 is 30 mm in outer diameter and has an iron solid core bar (22 mm in diameter), a rubber (4 mm in thickness), and a sponge (2 mm in thickness), for example. The fixing belt 53 is 60 mm in outer diameter and has a nickel base material (35 micrometers in thickness), a rubber (200 micrometers in thickness), and a PFA (30 micrometers in thickness), for example.

The pressure-side rotation unit 32 has a pressure roller 54. The pressure roller 54 is 35 mm in outer diameter and has an iron hollow cored bar (2.5 mm in thickness), a rubber (2.5 mm in thickness), and a PFA (Perfluoroalkoxy, 30 micrometers in thickness), for example.

A fixing-side heating section is provided to heat the fixing-side rotation unit 31. The fixing-side heating section is composed of a heating-side long heater 55 and a heating-side short heater 56, which are incorporated in the heating roller 51. The heating-side long heater 55 is exemplified by a halogen lamp heater (1150 W, emission length of 290 mm), and the heating-side short heater 56 is exemplified by a halogen lamp heater (790 W, emission length of 180 mm).

A pressure-side heating section is provided to heat the pressure-side rotation unit 32. The pressure-side heating section is constituted of a pressure-side heater 57, which is incorporated in the pressure roller 54. The pressure-side heater 57 is exemplified by a halogen lamp heater (230 W, emission length of 290 mm). The fixing-side heating section and the pressure-side heating section are not turned on at the same time. Specifically, they are so structured that ON/OFF control of the pressure-side heating section is operated only when the fixing-side heating section is turned off in the state where the fixing-side heating section is subjected to ON/OFF control. This means that current is preferentially passed to the fixing-side heating section, and therefore the pressure-side heating section is not turned on when the fixing-side heating section is in the ON state.

A first temperature sensor is provided to detect the temperature of the fixing-side rotation unit 31. The first temperature sensor is constituted of a heating-side thermistor 58, which is placed in contact with the heating roller 51.

A second temperature sensor is provided to detect the temperature of the pressure-side rotation unit 32. The second temperature sensor is constituted of a pressure-side thermistor 59, which is placed in non-contact with the pressure roller 54.

A heating-side thermostat 60 is provided to control the temperature of the fixing-side rotation unit 31. The heating-side thermostat 60 is placed 1 mm away from the fixing belt 53 near the center of the axial-direction of the fixing belt 53.

A pressure-side thermostat 61 is provided to control the temperature of the pressure-side rotation unit 32. The pressure-side thermostat 61 is placed 1 mm away from the pressure roller 54 near the center of the axial-direction of the pressure roller 54.

Description is now given on operation of the fixing device 30. An operation for heating the surface of the fixing belt 53 and the pressure roller 54 up to a printable temperature after power-on of the apparatus is referred to as a warm-up operation. A time taken for this operation is referred to as a warm-up time. The warm-up operation is performed at the time of the power source being turned on again after being turned off, and at the time of return from unjamming operation, cover closing, return from a sleep mode or the like.

In the warm-up operation, the heating-side long heater 55 is turned on to raise the temperature to the printable temperature. In this case, the heating-side long heater 55 is maintained in the ON state, and therefore the pressure-side heater 57 is put in the OFF state, as stated above.

At the time of stop, the pressure roller 54 and the fixing roller 52 are in a light pressure contact state so as to prevent any creep deformation of the fixing roller 52. During rotation, the pressure roller 54 and the fixing roller 52 are put in full pressure-contact state. In the full pressure-contact state, driving force is transmitted to an unshown drive gear in order to rotate the pressure roller 54, so that the fixing belt 53, the fixing roller 52 and the heating roller 51 are rotated by following the rotation of the pressure roller 54. Thereby, heat from insides of the heating roller 51 and the pressure roller 54 is transferred to the fixing belt 53 and the surface of the pressure roller 54.

Upon power-on of the apparatus, the heater is turned on and the roller starts to rotate. Turning-on of the heater and rotation of the roller allow the fixing belt 53 and the surface of the pressure roller 54 to be heated up to the printable temperature. A “ready” flag indicating permission of printing is set when not only temperature detected by the heating-side thermistor 58 reaches a predetermined printable temperature, but also corrected temperature, which is obtained by adding a non-contact segment to temperature detected by the pressure-side thermistor 59, reaches a predetermined printable temperature. For example, the ready flag is set when the temperature detected by the heating-side thermistor 58 reaches 190° C. and the temperature corrected by adding the above-stated correction to the temperature detected by the pressure-side thermistor 59 reaches 150° C.

If no print signal is given at this point, the fixing roller 52 and the pressure roller 54 are put in a light pressure contact state, and the apparatus is in a printing standby state. If the print signal is given, the fixing roller 52 and the pressure roller 54 are put in a full pressure contact state, and printing operation is started.

In the standby state, rotation of the fixing roller 52 and the pressure roller 54 is stopped in the light pressure contact state, and the heaters 55, 56, 57 are controlled to keep certain preset temperatures. The preset temperature on the heating side is 190° C., for example. The heating-side long heater 55 is on/off-controlled by using the detected temperature of the heating-side thermistor 58 as an input of the heater 55. The preset temperature on the pressure side is 150° C., for example. The pressure-side heater 57 is on/off-controlled by using the corrected temperature as an input of the heater 57, wherein the corrected temperature is obtained by adding the correction to the temperature detected by the pressure-side thermistor 59. In this case, as mentioned above, the pressure-side heater 57 is not turned on as long as the heating-side long heater 55 is in the ON state.

In start-up of printing operation, before the recording material S enters into the fixing device 30, the fixing roller 52 and the pressure roller 54 rotate in a full pressure contact state. Thereby, the heat of the heating roller 51 and the pressure roller 54 is transferred to the surfaces of the fixing belt 53 and pressure roller 54, resulting in temperature increase. In the case where the preset temperature on the heating side is 190° C. for example, the heating-side long heater 55 or the heating-side short heater 56 is on/off-controlled by using the temperature detected by the heating-side thermistor 58 as an input. Selection in the heating section to is determined by an unshown heating section selection control section. Specifically, the heating section selection control section selects the heating-side short heater 56 in the case where images are printed on recording sheets having width of less than 216 mm, while it selects the heating long heater 57 in the case where images are printed on recording sheets having width of 216 mm or more. In the case of the pressure-side temperature 150° C., the pressure-side heater 57 is on/off-controlled by using the corrected temperature as an input of the pressure-side heater 57, wherein the corrected temperature is obtained by correcting the temperature detected by the pressure-side thermistor 59.

For example, if the heating-side thermistor 58 detect no correct temperature due to some failure, current may be continuously passed to the heating-side long heater 55. As the result, the heating roller 51 may be heated above the preset temperature. This may lead to smoke generation or ignition. The heating-side thermostat 60 is placed as a protection section against such an overdrive.

The heating-side thermostat 60 is electrically connected to the heating-side long heater 55 and the heating-side short heater 56 in series, respectively. Therefore, when the heating-side thermostat 60 operates to turn off, electric power supply to the long heater 55 and the short heater 56 is blocked. Heat is transmitted from the heating roller 51 to the fixing belt 53, and then from the fixing belt 53 to the heating-side thermostat 60. When the preset temperature of the heating-side thermostat 60 is 210° C. for example, the thermostat 60 operates to turn off at the time of reaching the temperature of 210° C. Thereby, electric power supply to the long heater 55 and the short heater 56 is blocked to prevent further increase in temperature.

During the warm-up operation, the standby operation and the normal-size paper feed operation, the long heater 55 is selectively turned on. On the other hand, in the case of the small-size paper feed operation, the short heater 56 is selectively turned on, so as to prevent temperature rise at the axial end sections of the heating roller 51. If the end sections of the heating roller 51 are kept at a high temperature, the lifetime of the fixing device is shortened. Also, uneven distribution in the axial temperature of the heating roller 51 may cause uneven distribution in quality of axial fixed image, paper wrinkling or other problems. Thus, there are preferably provided a plurality of the heating sections having different heating regions.

For measuring a temperature on the surface of the fixing belt 53, a noncontact-type temperature sensing device is sometimes employed because a contact-type temperature sensing device easily gives damage to the fixing belt 53 by direct contact with the surface of the fixing belt 53 to result in an image noise. However, the noncontact-type temperature sensing device is less preferable since it provides a temperature gap larger than that in the contact-type device. Therefore, it is preferable to employ a contact-type temperature sensing device, and particularly, to place a contact-type thermistor 58 on the heating roller 51. Detection of the surface temperature of the heating roller 51 makes it possible to more stabilize the temperature of the fixing belt 53 in front of the nip section than detection of the surface temperature of the fixing belt 53.

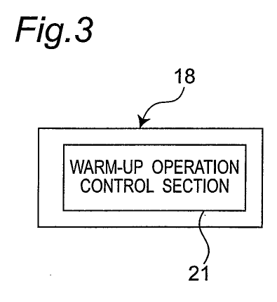

As shown in FIG. 3, the control device 18 in the image forming apparatus has a warm-up operation control section 21. In the case of forming a monochrome image, the warm-up operation control section 21 performs warm-up operation of the fixing-side rotation unit 31 and the pressure-side rotation unit 32 from start-up until the temperature of the fixing-side rotation unit 31 exceeds a specified value, based on an output of the heating-side thermistor 58 In the case of forming a color image, the warm-up operation control section 21 performs warm-up operation of the fixing-side rotation unit 31 and the pressure-side rotation unit 32 from start-up until the temperature of the pressure-side rotation unit 32 exceeds an other specified value, based on an output of the pressure-side thermistor 59.

The monochrome image herein refers to an image in which one layer of toner t in one color is formed on a recording material S. The color image refers to an image in which a plurality of layers (e.g., 2 to 3 layers) of toner t in different colors is formed on a recording material S.

The required fixing quality for the monochrome image is that a surface image made of single-layered toner t should not be removed even by friction between paper sheets or the like. Thus, the warm-up conditions for fixing the monochrome image are determined based on the temperature of the heating roller 51 (fixing belt 53) located on the image surface side. On the other hand, the required fixing quality for the color image is that the lower side of the multi-layered toner t should be melted to be adhered onto a paper sheet. Thus, the warm-up conditions for fixing the color image are determined based on the temperature of the pressure roller 54 located on the non-image surface side.

In the case of forming the color image, the warm-up operation control section 21 may perform warm-up operation of the fixing-side rotation unit 31 and the pressure-side rotation unit 32 from start-up till it is determined that the temperature of the fixing-side rotation unit 31 exceeds the specified value based on an output of the heating-side thermistor 58 and that the temperature of the pressure-side rotation unit 32 exceeds the other specified value based on an output of the pressure-side thermistor 59.

The specified value of the fixing-side rotation unit 31 is higher than the other specified value of the pressure-side rotation unit 32. A time taken from start-up until the temperature of the fixing-side rotation unit 31 exceeds the specified value is shorter than a time taken from start-up until the temperature of the pressure-side rotation unit 32 exceeds the other specified value.

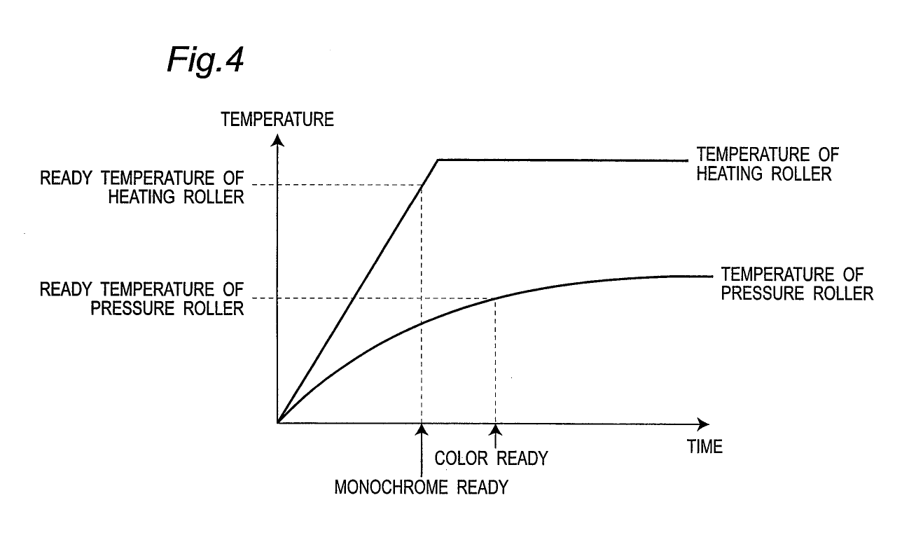

Description is given on the conditions for permitting fixation of an image formation layer in the present embodiment. FIG. 4 shows the relation between temperature of the heating roller and temperature of the pressure roller, and shows completion conditions of the warm-up for fixing operation in monochrome and color modes.

The temperature rising rate of the fixing belt 53 located on the image surface side is very high. Therefore, the heating roller 51 first reaches a monochrome image fixable temperature (“READY TEMPERATURE OF HEATING ROLLER” in FIG. 4), so that a monochrome print permission (“MONOCHROME READY” in FIG. 4) is issued. When there is no print command, the heating roller 51 is continuously rotated at the temperature higher than the monochrome image fixable temperature in order to raise the temperature of the pressure roller 54 as quickly as possible. Thereafter, the temperature of the pressure roller 54 reaches a prescribed temperature (“READY TEMPERATURE OF PRESSURE ROLLER” in FIG. 4), and then a color print permission (“COLOR READY” in FIG. 4) is issued.

In the case of a monochrome image, the paper sheet surface is required to have a sufficiently high temperature. Therefore, a condition setting thereof is conducted by setting a temperature of the heating roller to the ready temperature of heating roller. In the case of the color image, the paper sheet back surface is required to have a sufficiently high temperature. Therefore, a condition setting thereof is conducted by setting a temperature of the pressure roller to the ready temperature of the pressure roller.

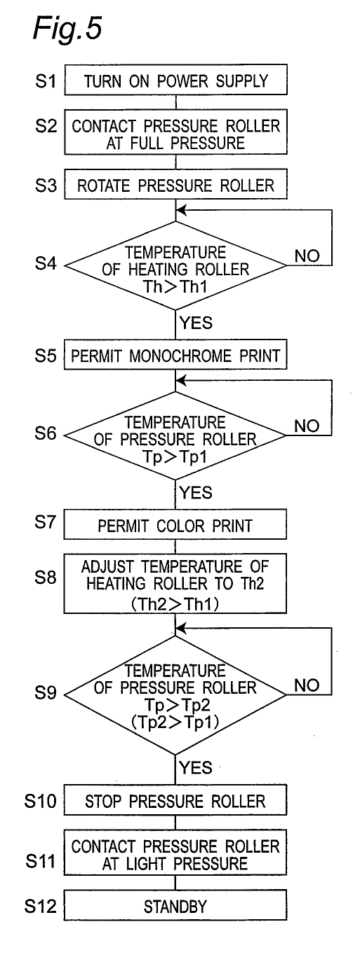

With reference to FIG. 5, description is now given on the control flow chart of the image forming apparatus according to the embodiment.

First, a power supply is turned on (Step S1). Then, the pressure roller contacts the fixing roller at full pressure (Step S2). The pressure roller is rotated to rotate the fixing belt together (Step S3).

The heating roller is heated till temperature of the heating roller Th exceeds a specified value Th1 (Step S4). Then, a monochrome print permission is issued (Step S5). The pressure roller is heated till temperature of pressure roller Tp exceeds an other specified value Tp1 (Step S6). Then, a color print permission is issued (Step S7).

Thereafter, the temperature of the heating roller is adjusted to be a prescribed temperature Th2 (Th2>Th1) (Step S8). The pressure roller is heated till temperature of pressure roller Tp exceeds a prescribed value Tp2 (Tp2>Tp1) (Step S9), before the pressure roller is stopped (Step S10). The pressure roller contacts the fixing roller at light pressure (Step S11), and then, the apparatus is put in a standby state (Step S12).

According to the above-structured image forming apparatus, in the case of forming the monochrome image, the warm-up operation control section 21 performs warm-up operation of the fixing-side rotation unit 31 and the pressure-side rotation from start-up unit 32 until the temperature of the fixing-side rotation unit 31 exceeds a specified value, based on an output of the heating-side thermistor 58. In the case of forming the color image, the warm-up operation control section 21 performs warm-up operation of the fixing-side rotation unit 31 and the pressure-side rotation unit 32 from start-up until the temperature of the pressure-side rotation unit 32 exceeds an other specified value, based on an output of the pressure-side thermistor 59. Time required for the temperature of the fixing-side rotation unit to exceed the specified value is shorter than time required for temperature of the pressure-side rotation unit to exceed the other specified value. Therefore, in the case of forming the monochrome image, it is not necessary to put the apparatus in a standby state until the temperature of the pressure-side rotation unit 32 exceeds the other specified value.

Thus, the warm-up time in using the monochrome mode can be reduced, and thereby the waiting time of the users using the monochrome mode can be reduced.

Also, according to the above-structured image forming apparatus, in the case of forming the color image, the warm-up operation control section 21 performs warm-up operation of the fixing-side rotation unit 31 and the pressure-side rotation unit 32 from start-up not only until it is determined that the temperature of the fixing-side rotation unit 31 exceeds the specified value, based on an output of the heating-side thermistor 58, but also until it is determined that the temperature of the pressure-side rotation unit 32 exceeds the other specified value from start-up till, based on an output of the pressure-side thermistor 59. In the case of forming the color image, therefore, even if the temperature of the fixing-side rotation unit 31 does not over the specified value by the time when the temperature of the pressure-side rotation unit 32 exceeds the other specified value, the warm-up operation continues until the temperature of the fixing-side rotation unit 31 exceeds the specified value. This ensures good formation of the color image.

Moreover, according to the above-structured image forming apparatus, the specified value of the fixing-side rotation unit 31 is higher than the other specified value of the pressure-side rotation unit 32, so that good formation of the color image is ensured.

The present invention shall not be limited to the above-disclosed embodiments. For example, the pressure-side rotation unit 32 may be heated via the fixing-side rotation unit 31 by the fixing-side heating section (heating-side heaters 55, 56) without the pressure-side heating section (the pressure-side heater 57). The fixing-side rotation unit 31 may be formed into a single roller. The pressure-side rotation unit 32 may be formed into a pair of rollers with a belt. The fixing-side heating section and the pressure-side heating section may have an electromagnetic induction heating structure instead of the commonly-used heater. Moreover, the first temperature sensor and the second temperature sensor may be constituted by thermocouples instead of thermistors. The image forming apparatus may be any apparatus including monochrome/collar copying machines, printers, facsimiles, and multi-functional machines having these functions.

The invention being thus described, it will be obvious that the invention may be varied in many ways. Such variations are not be regarded as a departure from the spirit and scope of the invention, and all such modifications as would be obvious to one skilled in the art are intended to be included within the scope of the following claims.

What is claimed is:

1. An image forming apparatus, comprising:
a fixing-side rotation unit;
a fixing-side heating section which heats the fixing-side rotation unit;
a pressure-side rotation unit which contacts the fixing-side rotation unit to form a nip section;
a first temperature sensor which detects temperature of the fixing-side rotation unit;
a second temperature sensor which detects temperature of the pressure-side rotation unit; and
a warm-up operation control section which performs warm-up operation of the fixing-side rotation unit and the pressure-side rotation unit from start-up until temperature of the fixing-side rotation unit exceeds a first specified value based on an output of the first temperature sensor in a case of forming a monochrome image, and which performs warm-up operation of the fixing-side rotation unit and the pressure-side rotation unit from start-up until temperature of the pressure-side rotation unit exceeds a second specified value based on an output of the second temperature sensor in a case of forming a color image, wherein
time required for the temperature of the fixing-side rotation unit to exceed the first specified value is set shorter than time required for temperature of the pressure-side rotation unit to exceed the second specified value.

2. The image forming apparatus set forth in claim 1, wherein
the warm-up operation control section performs warm-up operation of the fixing-side rotation unit and the pressure-side rotation unit from start-up not only until it is determined that temperature of the fixing-side rotation unit exceeds the first specified value based on the output of the first temperature sensor, but also until it is determined that temperature of the pressure-side rotation unit exceeds the second specified value based on the output of the second temperature sensor, in case of forming the color image.

3. The image forming apparatus set forth in claim 1, wherein
the first specified value of the fixing-side rotation unit is higher than the second specified value of the pressure-side rotation unit.

4. The image forming apparatus set forth in claim 1, wherein
the pressure-side rotation unit is heated by the fixing-side heating section via the fixing-side rotation unit.

5. The image forming apparatus set forth in claim 1, further comprising:
a pressure-side heating section which heats the pressure-side rotation unit, wherein
the fixing-side heating section and the pressure-side heating section are not turned on at the same time.
